(19) United States
(12) Patent Application Publication
(10) Pub. No.: US 2012/0084953 A1
(43) Pub. Date: Apr. 12, 2012

(54) UNIVERSAL CASKET AND VAULT LIFTING AND LOWERING DEVICE

(75) Inventors: Paul Eric Herridge, Auburn, NY (US); Dan Meiser, Wilder, KY (US); Edward Charles Wolff, Rochester, NY (US); Greg Wray, Guilford, IN (US)

(73) Assignee: Batesville Services, Inc., Batesville, IN (US)

(21) Appl. No.: 13/219,172

(22) Filed: Aug. 26, 2011

Related U.S. Application Data
(60) Provisional application No. 61/391,201, filed on Oct. 8, 2010.

(51) Int. Cl. A61G 19/00

(52) U.S. Cl. 27/32

(57) ABSTRACT

A universal casket and vault lifting and lowering device comprises four corner posts, a pair of end tubes, one of which is connected between two of the corner posts at each end of the device, a pair of side tubes, one of which is connected between two of the corner posts at each side of the device, a pair of straps, each having opposite ends rotatably fixed to a respective one of the side tubes, a power transmission assembly for rotating the pair of side tubes in a first direction to wind the straps around the side tubes to take up slack in the straps and for rotating the pair of side tubes in a second direction to unwind the straps and create slack in the straps, and a gear mounted to one of the side tubes which, when rotated, rotates both of the side tubes in the first direction and bypasses a portion of the power transmission assembly.

### RELATED APPLICATIONS

This application claims the benefit of U.S. Provisional Patent Application Ser. No. 61/391,201 filed Oct. 8, 2010, which is hereby incorporated by reference herein as if fully set forth in its entirety.

### FIELD

The subject matter herein relates generally to caskets and vaults, and more particularly to apparatus for lifting and lowering a casket and a vault.

### BACKGROUND

Caskets have traditionally been employed for burial of the dead. Often the casket is secured in a vault prior to burial. Currently two separate pieces of equipment are utilized to place the vault in the grave and the casket in the vault: a vault jack, and a casket lowering device.

After the grave is dug, a grave board (typically fabricated of aluminum) is placed along each longer side and each shorter end of the grave in a rectangular pattern forming a grave frame. A center grave board is placed on the rectangular grave frame midway between the sides, spanning the length of the grave frame. The vault is positioned on the center grave board.

Next the vault lowering device or vault jack is assembled on the rectangular grave frame. The vault jack has two pairs of corner posts and an end tube connected between each pair of corner posts. Each end tube carries a pair of cable spools. A cable is run from each cable spool on one end tube, under the vault, and is connected to a respective cable spool on the other end tube. One of the corner posts of the vault jack accepts a removable handle which, when rotated, imparts rotation to the two end tubes and hence cable spools through a power transmission assembly. Rotation of the two end tubes in one direction winds the cables around the end tubes to take up slack in the cables; rotation of the end tubes in the other direction unwinds the cables and creates slack in the cables. Examples of vault lowering devices are shown in U.S. Pat. Nos. 2,457,671, 3,364,536, and 4,716,636. Vault lowering devices are commercially available from American Cemetary Supplies, Inc., Portsmouth, Va., www.acsupplies.com, and T&J Manufacturing Corp., Maquoketa, Iowa, www.tjmanufacturing.qwestoffice.net/5001.html.

Once the vault jack is assembled, the vault lid is removed, and the vault is raised slightly with the vault jack by rotating the jack handle. The center grave board is then removed. The vault is then lowered by rotating the jack handle to provide clearance for the casket lowering device.

Next, the casket lowering device is assembled on top of the vault jack. The casket lowering device has four corner posts, two shorter end tubes, one of which is connected between the two corner posts at each end, and two longer side tubes, one of which is connected between the two corner posts at each side. A pair of straps has their opposite ends fixed to each of the two side tubes. One of the corner posts of the casket lowering device accepts a removable handle which, when rotated, imparts rotation to the side tubes through a power transmission assembly in the corner post and in the tubes. The power transmission assembly typically comprises a worm, rotated by the handle, which engages a worm gear mounted on a shaft within one of the end tubes, the shaft carrying a bevel gear at each end, each of which engages a bevel gear on an end of a respective one of the side tubes. Rotation of the handle thus rotates the side tubes. Rotation of the side tubes in one direction winds the straps around the side tubes to take up slack in the straps; rotation of the side tubes in the other direction unwinds the straps and creates slack in the straps. Examples of casket lowering devices are shown in U.S. Pat. Nos. 1,188,686, 1,402,781, 2,008,444, 2,008,445, 2,560,450, and 2,870,519, all assigned to the Frigid Fluid Company, and all hereby incorporated by reference herein as if fully set forth in their entirety. Such a casket lowering device is commercially available from the Frigid Fluid Company, Northlake, Ill., www.frigidfluidco.com.

Once the casket lowering device is assembled, the slack is removed from the straps by rotating the casket lowering device handle, and the casket is placed atop the casket lowering device. The casket lowering device may include a pair of elongated rollers mounted to each side tube of the lowering device and one elongated roller mounted to one end tube to assist in guiding the casket onto the lowering device. When it is time to lower the casket into the vault, the pairs of elongated rollers mounted to each side tube are pivoted downwardly away from the casket so that it is supported on just the straps. A brake is then released on the lowering device and the casket descends by its own weight, the speed of descent governed by a governor in the power transmission assembly.

Once the casket is positioned in the vault, the straps are removed from under the casket, and the casket lowering device is removed from atop the vault jack.

The vault with casket therein can then raised to a comfortable height so that the vault lid can be secured to the vault with fasteners. Finally, the vault is lowered into the grave, the cables are removed from under the vault, and the vault jack is disassembled and removed.

It is desirable to simplify the process of vault and casket interment and to reduce the amount of equipment required for same.

### SUMMARY

In one aspect, a universal casket and vault lifting and lowering device comprises four corner posts, a pair of end tubes, one of which is connected between two of the corner posts at each end of the device, a pair of side tubes, one of which is connected between two of the corner posts at each side of the device, a pair of straps, each having opposite ends rotatably fixed to a respective one of the side tubes, a power transmission assembly for rotating the pair of side tubes in a first direction to wind the straps around the side tubes to take up slack in the straps and for rotating the pair of side tubes in a second direction to unwind the straps and create slack in the straps, and a gear mounted to one of the side tubes which, when rotated, rotates both of the side tubes in the first direction and bypasses a portion of the power transmission assembly.

In another aspect, a universal casket and vault lifting and lowering device comprises four corner posts, a pair of end tubes, one of which is connected between two of the corner posts at each end of the device, a pair of side tubes, one of which is connected between two of the corner posts at each side of the device, a pair of straps, each having opposite ends rotatably fixed to a respective one of the side tubes, and a power transmission assembly for rotating the pair of side tubes in a first direction to wind the straps around the side tubes to take up slack in the straps and for rotating the pair of side tubes in a second direction to unwind the straps and create slack in the straps, each end of each of the pair of side tubes being removably connected to a respective shaft, extending from a respective corner post, by a removable pin.

In another aspect, a universal casket and vault lifting and lowering device comprises four corner posts, a pair of end tubes, one of which is connected between two of the corner posts at each end of the device, a pair of side tubes, one of which is connected between two of the corner posts at each side of the device, a first pair of straps, each having opposite ends rotatably fixed to a respective one of the side tubes, a second pair of straps, each having opposite ends looped around a respective one of the side tubes, and a power transmission assembly for rotating the pair of side tubes in a first direction to wind the first pair of straps around the side tubes to take up slack in the first pair of straps and for rotating the pair of side tubes in a second direction to unwind the first pair of straps and create slack in the first pair of straps, rotation of the side tubes neither winding nor unwinding the second pair of straps.

The power transmission assembly can comprise a worm, rotatable by a handle, the worm engaging a worm gear mounted on a shaft to impart rotation to the shaft, the shaft carrying a bevel gear at each end, and a bevel gear on an end of each side tube, each side tube bevel gear engaged by a respective one of the bevel gears on the shaft. When the gear mounted to the one side tube is rotated to rotate both of the side tubes in the first direction, the weight of a load lifted thereby is not transmitted through the worm and worm gear. The gear mounted to the one side tube can be engaged with and rotated by a spanner wrench.

In another aspect, a method of lowering a vault and a casket into a grave, the vault having a vault base and a vault lid, comprises providing a universal casket and vault lifting and lowering device comprising four corner posts, a pair of end tubes, one of which is connected between two of the corner posts at each end of the device, a pair of side tubes, one of which is connected between two of the corner posts at each side of the device, a first pair of straps, each strap having opposite ends rotatably fixed to a respective one of the side tubes, a second pair of straps, each strap having opposite ends looped around a respective one of the side tubes, and a power transmission assembly for rotating the pair of side tubes in a first direction to wind the first pair of straps around the side tubes to take up slack in the first pair of straps and for rotating the pair of side tubes in a second direction to unwind the first pair of straps and create slack in the first pair of straps, rotation of the side tubes neither winding nor unwinding the second pair of straps, positioning the first pair of straps beneath the vault base, operating the power transmission assembly to lower the vault base with the first pair of straps until the vault base is supported by the second pair of straps, removing the first pair of straps from beneath the vault base, positioning the first pair of straps beneath the casket, operating the power transmission assembly to lower the casket with the first pair of straps until the casket is supported by the vault base, removing the first pair of straps from beneath the casket, positioning the first pair of straps beneath the vault base, operating the power transmission assembly to lift the vault base and casket with the first pair of straps, removing the second pair of straps from beneath the vault base, and operating the power transmission assembly to lower the vault base and casket into the grave with the first pair of straps.

The universal casket and vault lifting and lowering device of the method can further comprise a gear mounted to one of the side tubes which, when rotated, rotates both of the side tubes in the first direction and bypasses a portion of the power transmission assembly. The step of operating the power transmission assembly to lift the vault base and casket with the first pair of straps can comprise rotating the gear mounted to the one side tube. The power transmission assembly can comprise a worm, rotatable by a handle, the worm engaging a worm gear mounted on a shaft to impart rotation to the shaft, the shaft carrying a bevel gear at each end, and a bevel gear on an end of each side tube, each side tube bevel gear engaged by a respective one of the bevel gears on the shaft. When the gear mounted to the one side tube is rotated to rotate both of the side tubes in the first direction, the weight of the vault and casket lifted thereby is not transmitted through the worm and worm gear. The step of rotating the gear mounted to the one side tube can comprise rotating the gear with a spanner wrench. The method can further comprise the step of disengaging a brake mechanism of the power transmission assembly prior to rotating the gear mounted to the one side tube with a spanner wrench. The step of removing the second pair of straps from beneath the vault base can comprise detaching at least one end of each strap from its respective side tube. The second pair of straps can be positioned between the first pair of straps. The step of removing the first pair of straps from beneath the vault base can comprise detaching at least one end of each strap from its respective side tube. The method can further comprise the step of, subsequent to the step of removing the first pair of straps from beneath the casket and prior to the step of positioning the first pair of straps beneath the vault base, positioning the first pair of straps beneath the vault lid, and operating the power transmission assembly to lower the vault lid onto the vault base with the first pair of straps. The method can further comprise supporting the vault on a grave board, positioning the first pair of straps beneath the vault, operating the power transmission assembly to lift the vault with the first pair of straps, and removing the grave board from beneath the vault.

The device can further comprise a vault lid display structure. The vault lid display structure can comprise a generally vertical standard, an upwardly and rearwardly extending vault lid support arm mounted at an upper end of the standard, the support arm having a connecting portion on a forward end thereof and an upwardly extending bar on a rearward end thereof, the connecting portion connected to one of the side tubes of the device, a foot of the standard adapted to rest atop a generally horizontal supporting surface, an outer edge of the bar adapted to support an inner edge of a vault lid. Alternatively, the vault lid display structure can comprise a base adapted to rest atop a generally horizontal supporting surface, an upwardly extending back, a downwardly and forwardly extending vault lid support surface, a lip on a lower end of the support surface, and a connecting portion on an upper end of the back, the connecting portion connected to one of the side tubes of the device, an inner edge of the lip adapted to support an outer edge of a vault lid. The connecting portion or either display structure can be a downwardly facing hook.

### DRAWINGS

FIG. 1 is a perspective view of the universal casket and vault lifting and lowering device.

FIG. 2 is another perspective view of the device of FIG. 1 illustrating the detachable feature of the side tubes.

FIG. 3 is a perspective view of the device of FIGS. 1 and 2 with the side tubes detached from the corner posts.

FIG. 4 is an enlarged perspective view of a portion of the device of FIGS. 1-3 illustrating the power transmission in one of the corner posts and the side tube mounted gear and spanner wrench for operating the lifting function of the device and bypassing a portion of the power transmission assembly.

FIG. 5 is a side view of the gear and spanner wrench of FIG. 4.

FIG. 6 is an enlarged perspective view of an end of one of the second pair of straps looped around its side tube and removably connected to itself.

FIGS. 6A and 6B are side views of the strap connection of FIG. 6.

FIG. 7 is a perspective of the vault resting on the center grave board.

FIG. 8 is a perspective view of the corner posts and end tubes of the lifting and lowering device being adjusted for width on the grave frame.

FIG. 9 is a perspective view of the side tubes being adjusted for length and being connected to the corner posts.

FIGS. 10A-10D are end views of the first pair of straps being positioned under the vault and above the center grave board, the vault being lifted by the device with the use of the spanner wrench, and the center grave board being removed.

FIGS. 11A-11C are two end views and a side view, respectively, of the second pair of straps being positioned under the vault.

FIGS. 12A-12D are end views of the vault lid being removed from the vault and placed on a vault lid display structure.

FIGS. 13A-13D are an end view, two side views, and an end view, respectively, of the vault being lowered onto the second pair of straps and the first pair of straps being removed from beneath the vault.

FIGS. 14A-14C are end views of the first pair of straps being positioned under the casket and the casket being lowered into the vault.

FIGS. 15A-15C are end views of the first pair of straps being positioned under the vault lid and the vault lid being lowered onto the vault base.

FIGS. 16A-16D are end views of the first pair of straps being positioned under the vault, the vault and casket being lifted by the first pair of straps, the second pair of straps being removed from beneath the vault, and the vault and casket being lowered into the grave with the first pair of straps.

FIG. 17 is a view similar to FIG. 10A but enlarged.

FIG. 18A is a disassembled perspective view, enlarged, of an end of one of the first pair of straps removably attached, yet rotatably fixed once attached, to its side tube.

FIG. 18B is a view similar to FIG. 18A but assembled.

### DESCRIPTION

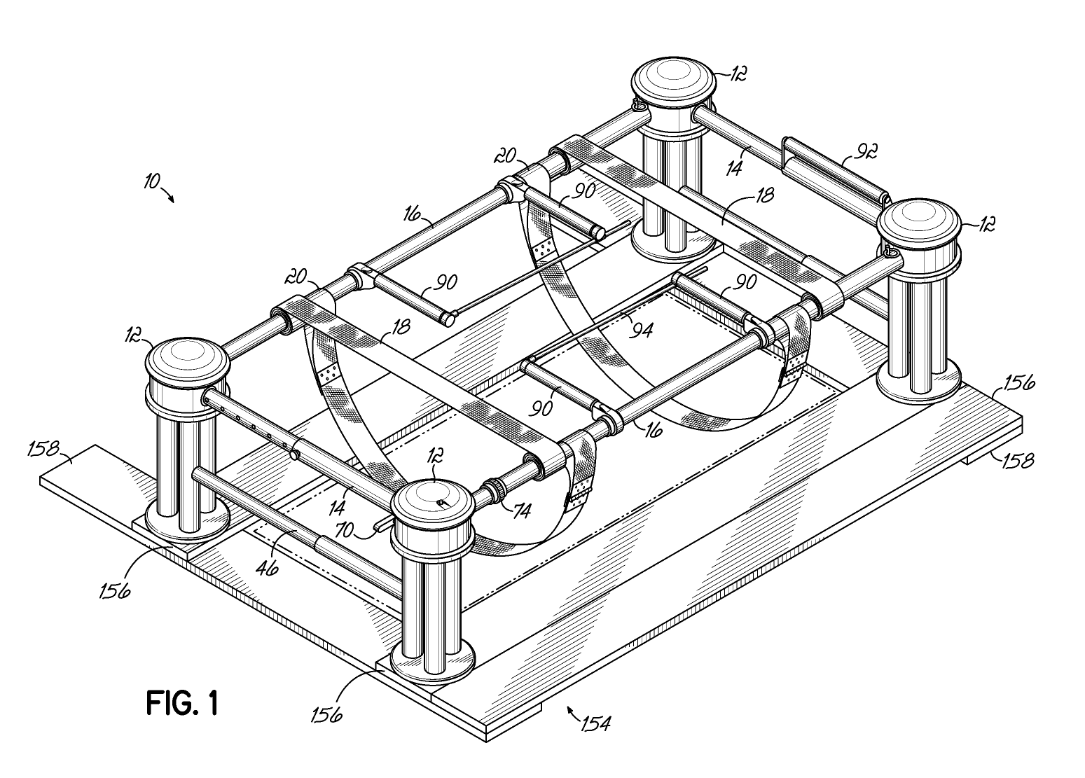

Referring first to FIG. 1, a universal casket and vault lifting and lowering device 10 is illustrated. The device 10 is particularly suited for use with the vault disclosed in the assignee's U.S. patent application Ser. No. 12/615,092 filed Nov. 9, 2009 entitled CASKET VAULT, which is hereby incorporated by reference herein as if fully set forth in its entirety. The vault of the '092 application has inner and outer walls fabricated of synthetic resinous material with a structural foam filler material between the inner and outer walls. Such a construction yields a vault and lid having a weight of around 225 lbs, which is significantly lighter than a traditional concrete vault with lid which can weigh on the order of 3,000 to 3,500 lbs. The vault of the '092 application also has novel features which lend itself to being manipulated by the device 10, which will be described below.

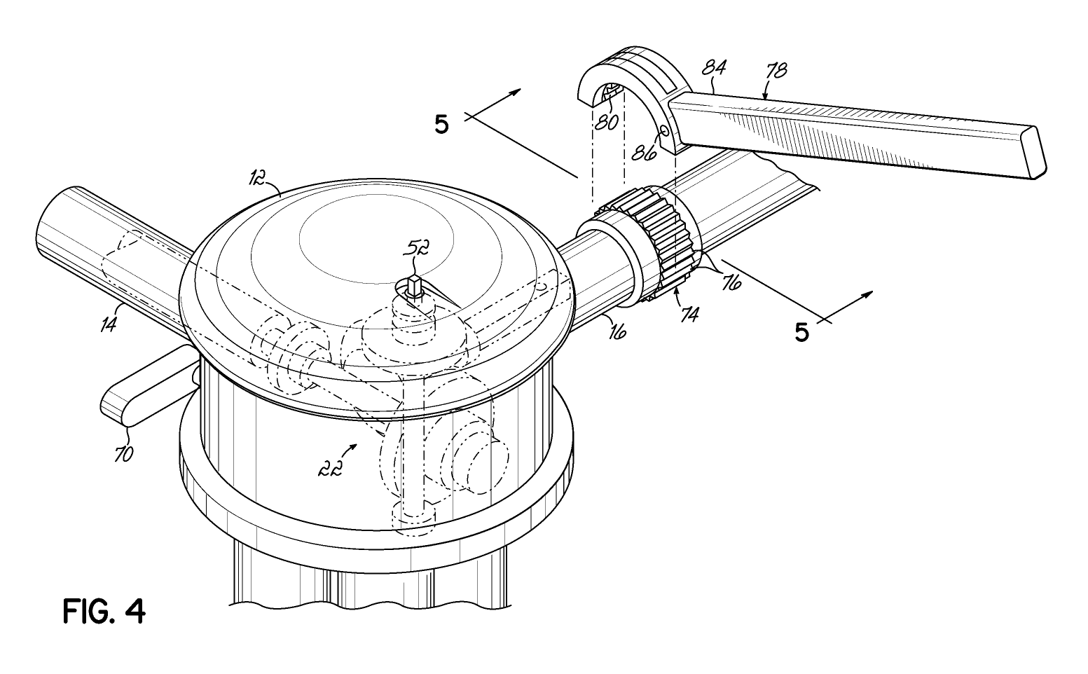

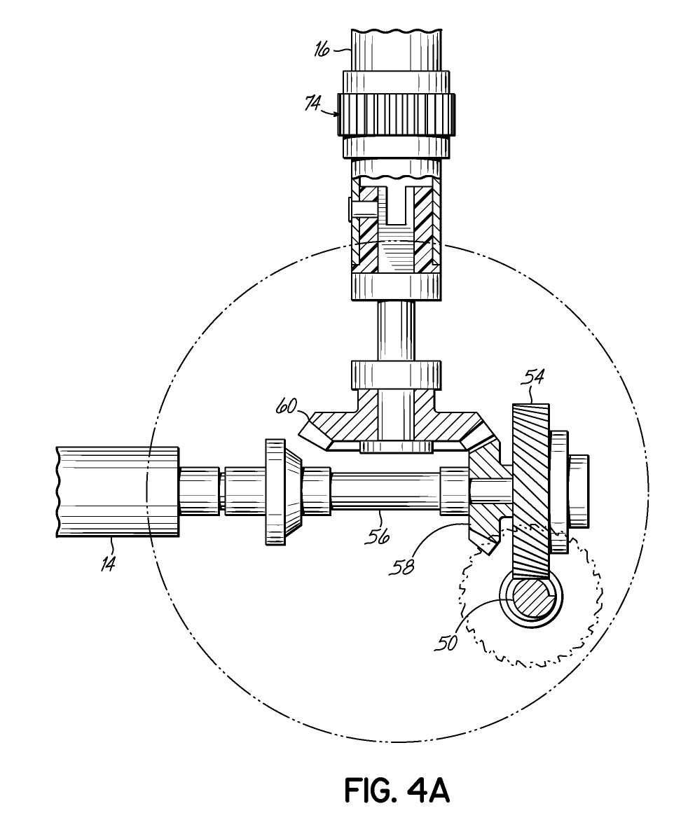

The device 10 comprises four corner posts 12, a pair of end tubes 14, one of which is connected between two of the corner posts 12 at each end of the device 10, a pair of side tubes 16, one of which is connected between two of the corner posts at each side of the device 10, a first pair of straps 18, each having opposite ends rotatably fixed, though removably attached, to a respective one of the side tubes 16, a second pair of straps 20, each having opposite ends looped around a respective one of the side tubes 16, and a power transmission assembly 22 (FIG. 4) for rotating the pair of side tubes 16 in a first direction to wind the first pair of straps 18 around the side tubes to take up slack in the first pair of straps 18 and for rotating the pair of side tubes 16 in a second direction to unwind the first pair of straps 18 and create slack in the first pair of straps. Rotation of the side tubes 16 neither winds nor unwinds the second pair of straps 20 as their ends are merely looped loosely around the side tubes 16 and connected to themselves.

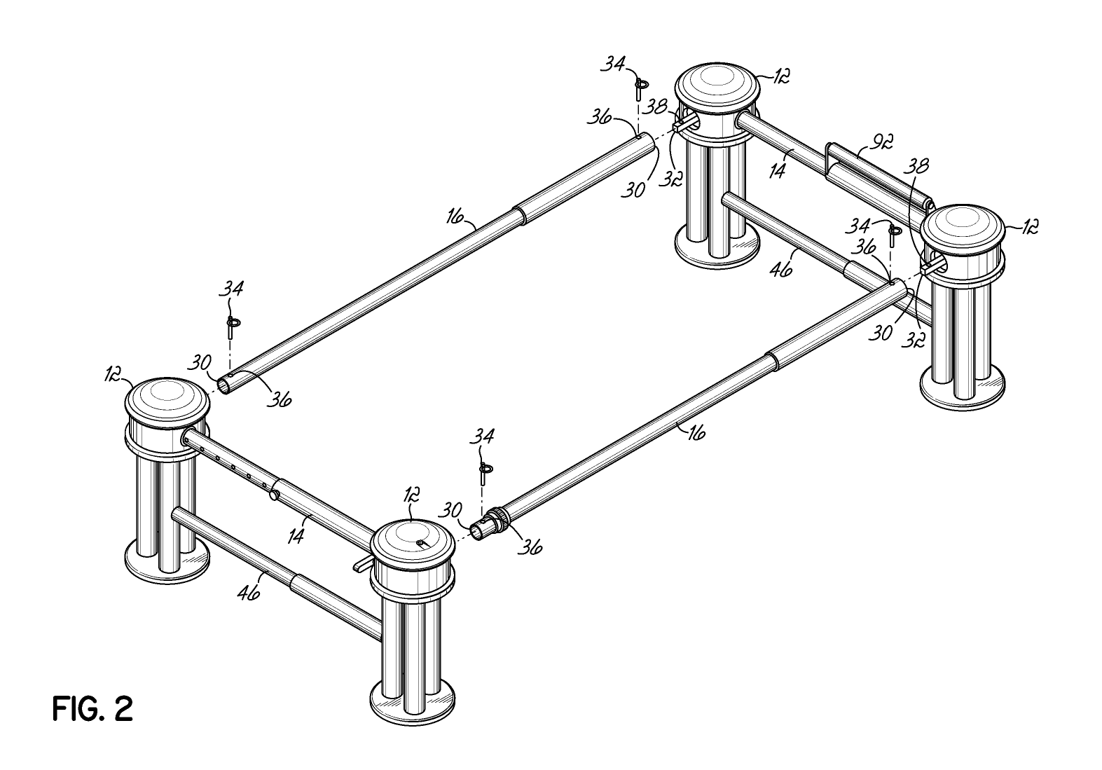

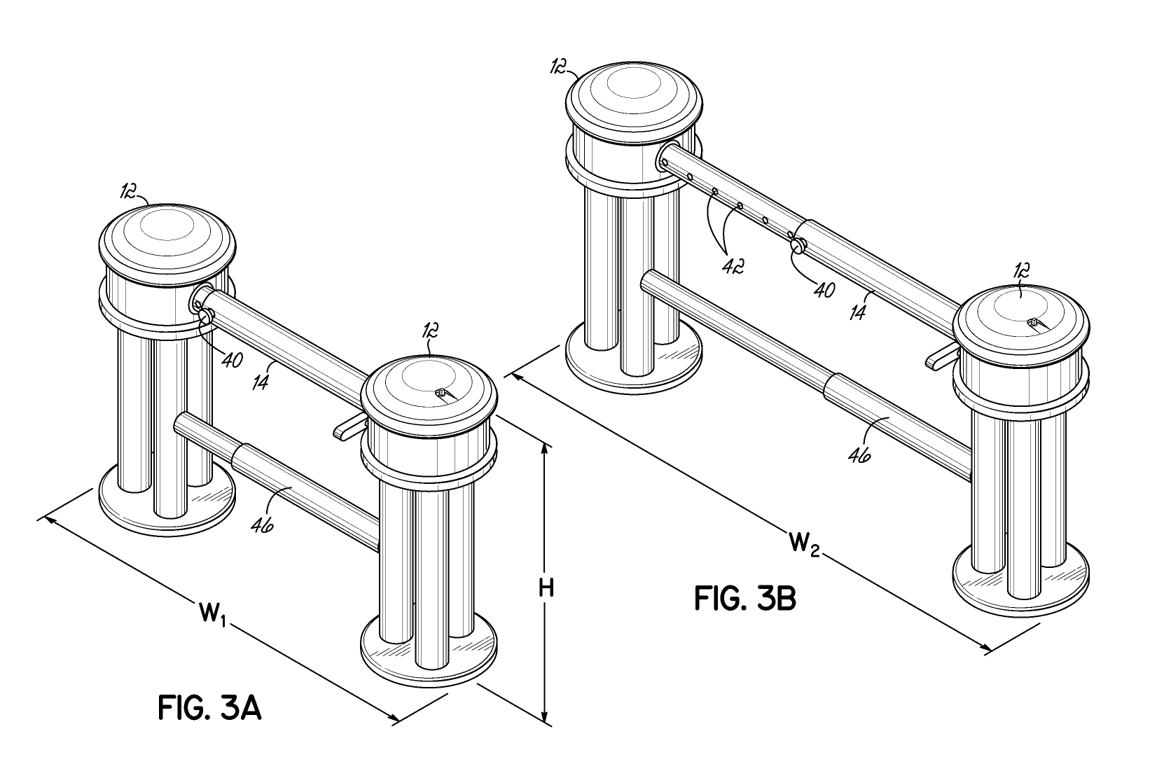

Referring to FIG. 2, each end 30 of each of the side tubes 16 can be removably connected to a respective rotatable shaft 32 by a pull pin 34 extending through holes 36, 38 in the tube 16 and shaft 32, respectively. In this manner, the device 10 can be broken down into four parts for easy carrying and transport. Side tubes 16 can telescope so as to provide for length adjustment of the device 10. As illustrated in FIGS. 3A and 3B, end tubes 14 can also telescope and may be set at any number of widths by pin 40 received in one of the holes 42. An additional end tube 46, also telescoping, may be included at each end of the device 10 for additional strength and stability.

Referring to FIG. 4, power transmission assembly 22 can include a worm 50, rotatable by a handle (not shown) at 52, the worm 50 engaging a worm gear 54 mounted on a shaft 56 within end tube 14 to impart rotation to the shaft 56, the shaft 56 carrying a bevel gear 58 at each end, and a bevel gear 60 on an end of each side tube 16, each side tube bevel gear 60 engaged by a respective one of the bevel gears 58 on the shaft 56. Power transmission assembly 22 can also include a brake mechanism (not shown but known to those skilled in the art) actuatable by a lever 70, and a governor mechanism (not shown but known to those skilled in the art) to govern the speed of descent of a casket and/or vault being lowered by the device 10.

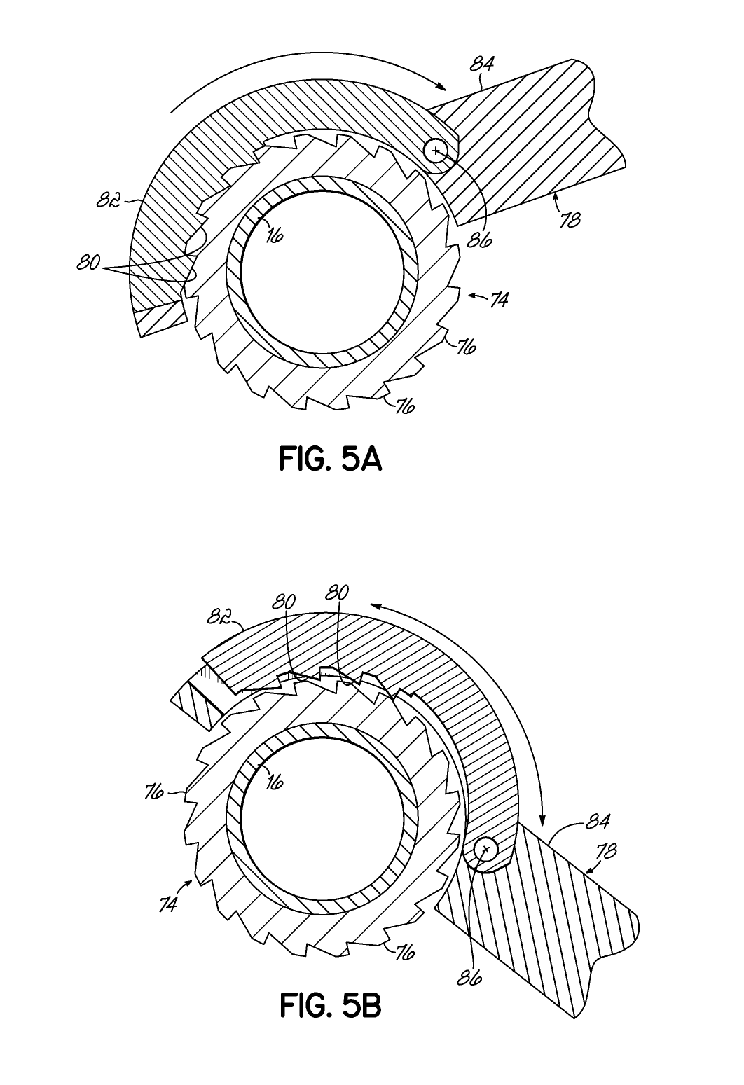

Referring still to FIG. 4, a gear 74 is fixedly attached to one of the side tubes 16, for example the side tube 16 corresponding to the post 12 containing the power transmission assembly 22. Gear 74 has gear teeth 76. Gear 74 is rotatable via a spanner wrench 78 having mating teeth 80. Teeth 80 are carried on an arm 82 pivoted to wrench handle 84 via pivot 86. The pivoting nature of the wrench teeth 80 permits a ratcheting effect whereby rotation of the wrench 78 in a clockwise direction (FIG. 5A) rotates gear 74 and hence side tube 16, whereas rotation of wrench 78 in a counter clockwise direction (FIG. 5B) causes arm 82 to pivot upwardly over teeth 76 on gear 74.

The worm gear 54 of the power transmission assembly 22 of a typical prior art casket lowering device is fabricated of a soft metal, for example bronze. As such, it is designed only to rotate the side tubes 16 with no load supported on the pair of straps 18. In other words, the worm gear 54 of a typical prior art power transmission assembly 22 is only designed to be used to rotate side tubes 16 in an unloaded condition to wind straps 18 around tubes 16 to take up slack in the pair of straps 16. By adding gear 74 on side tube 16 for actuation by spanner wrench 78, the side tubes 16 can be rotated while under a load, for example while supporting a casket or a vault, without the weight of the load being transmitted through the worm 50 and worm gear 54. This is because rotation of the side tube 16 via gear 74 and wrench 78 bypasses the worm 50 and worm gear 54 portion of the power transmission assembly 22, in that the bevel gear 60 on the side tube 16 with gear 74 thereon rotates mating bevel gear 58 on the shaft 56, and the bevel gear 58 on the opposite end of the shaft 56 rotates mating bevel gear 60 on the other side tube 16. Thus, a prior art casket lowering device can be thus retrofitted to raise the casket (or vault), without modifying the power transmission assembly 22. However, modifying the power transmission assembly 22 such that the worm 50 and worm gear 54 can withstand loads transmitted therethrough such that the device 10 can lift a casket or vault by rotating the worm 50 with the handle is nevertheless within the scope of the invention. Means other than the illustrated gear 74 with teeth 76 and spanner wrench 78 with teeth 80 could be used for gripping and rotating the side tube 16. For example, a standard nut could be fixedly secured to tube 16 and engaged with a standard adjustable wrench or box end or open end wrench. Any and all such means shall be deemed to be embraced by the terms “gear” and “spanner wrench.”

Referring back to FIG. 1, the device 10 can further include a pair of casket placer rollers 90 on each side tube, and an end roller 92 mounted on one of the end tubes 14. Rollers 90 and 92 facilitate sliding of a casket onto the device 10 from the end. A rod 94 can be used to connect each of the pairs of rollers 90 on each side of the device to further assist in sliding the casket onto the device 10 and preventing it from “nose diving” between the rollers 90. Rollers 90 include a mechanism (not shown but known to those skilled in the art) permitting them to be rotatably fixed relative to their respective side tube 16 in a generally horizontal casket supporting position, and permitting them to be rotated downwardly out of the way of the casket for lowering the casket.

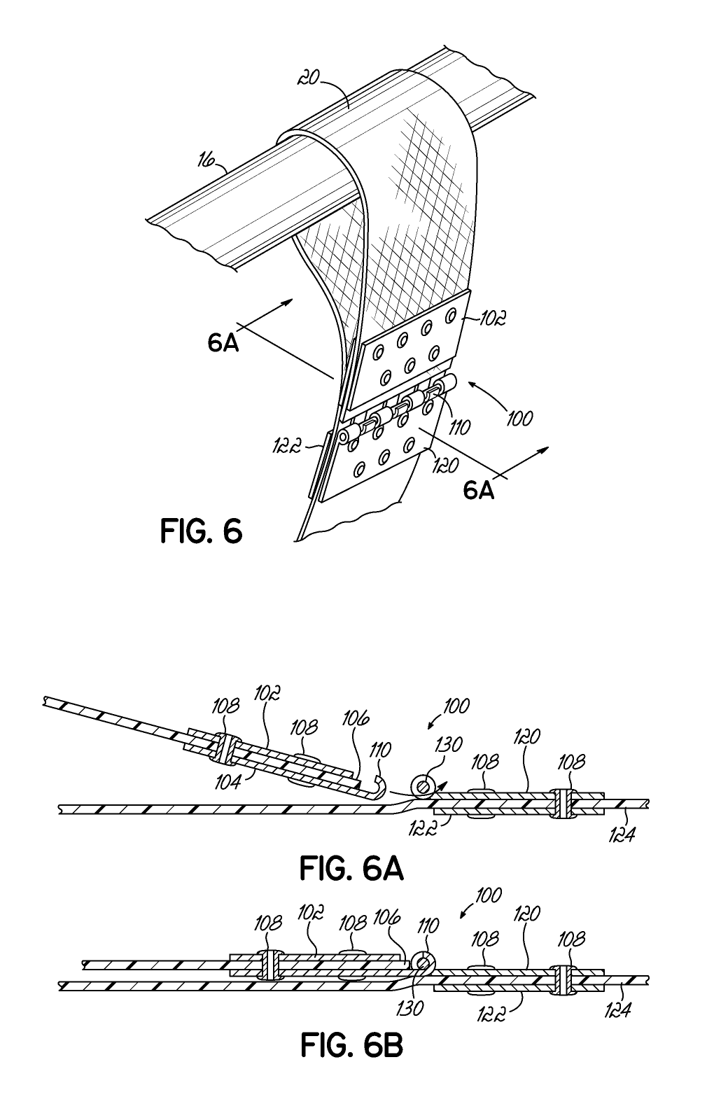

Referring to FIGS. 1, 6, 6A and 6B, the second pair of straps 20, unlike the first pair of straps 18, do not have their ends rotatably fixed to the side tubes 16. Rather, their ends are simply looped around the side tubes 16 such that rotation of the side tubes 16 neither winds nor unwinds the straps 20 around the tubes 16. A connector 100 is used to removably connect the strap 20 to itself. One half of the connector 100 includes a pair of plates 102, 104 secured to free end 106 of strap 20 with rivets 108. One of the plates 104 includes hook fingers 110. The other half of the connector 100 includes a pair of plates 120, 122 secured to a section 124 of strap 20 with rivets 108. One of the plates 120 includes a rod 130 around which hook fingers 110 are removably securable. Connectors 100 thus provide a means of readily attaching and detaching straps 20 to and from side tubes 16.

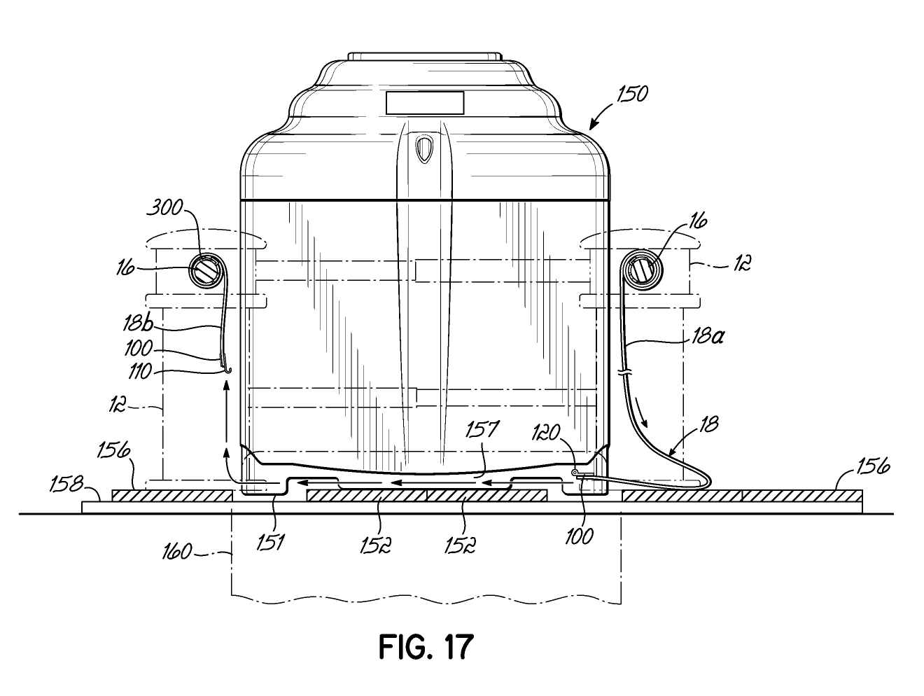

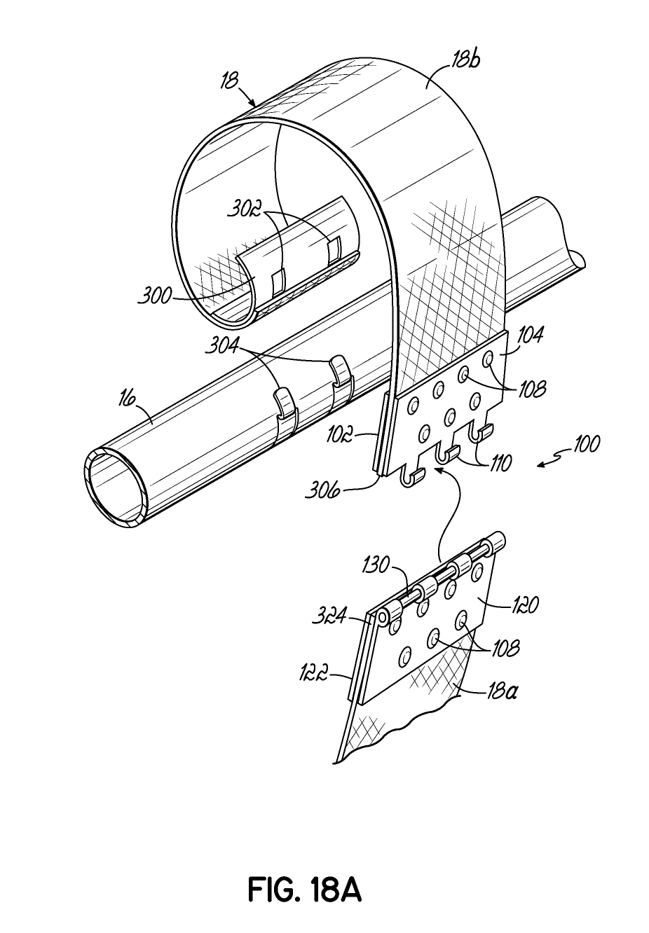

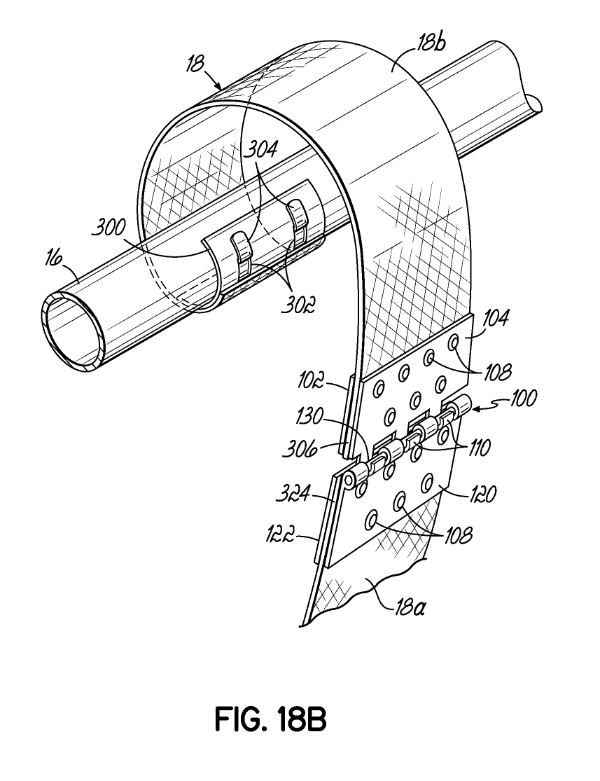

Referring to FIGS. 17-18B, the connection of the ends of the first pair of straps 18 to the side tubes 16 is illustrated. Each strap 18 includes a longer center section 18a and at least one shorter end section 18b, and preferably a pair of shorter end sections 18b. One of the shorter end sections 18b is removably attached to one end of the longer center section 18a and the other of the shorter end sections 18b is removably attached to the other end of the longer center section 18a. One end of each of the shorter sections 18b has a semi cylindrical connector 300 fixed to that end of the shorter section 18b with, for example, rivets (not shown). The connector 300 has a pair of slots 302 that accept a pair of finger tabs 304 on rotating side tube 16. The connector 300 is removably placed over side tube 16 and finger tabs 304 are removably received in slots 302. Once so assembled, that end of the strap 18 is rotatably fixed to side tube 16 such that rotating the tube 16 in a first direction winds that strap 18 around the side tube 16 to take up slack in that strap 18 and rotating the side tube 16 in a second opposite direction unwinds that strap 18 and creates slack in that strap 18.

To facilitate removing the pair of straps 18 from beneath the vault 150 after the vault 150 has been lowered into the grave (described below), a connector 100, similar to that used with the second pair of straps 20, can be used to removably connect the shorter straps sections 18b to the longer strap section 18a. With like numbers designating like elements, one half of the connector 100 includes a pair of plates 102, 104 secured to free end 306 of shorter strap section 18b with rivets 108. One of the plates 104 includes hook fingers 110. The other half of the connector 100 includes a pair of plates 120, 122 secured to free end 324 of longer strap section 18a with rivets 108. One of the plates 120 includes a rod 130 around which hook fingers 110 are removably securable. Connectors 100 thus provide a means of readily attaching and detaching the longer strap section 18a to the shorter strap sections 18b. Due to the flat geometry of the connector 100, as compared to the bulkier geometry of the semi-cylindrical connector 300, the longer strap section 18a is easier to withdraw from beneath the vault 150 after the vault 150 has been lowered into the grave than if such a connector 100 was not used thus requiring an operator to pull the bulkier connector 300 from beneath the vault.

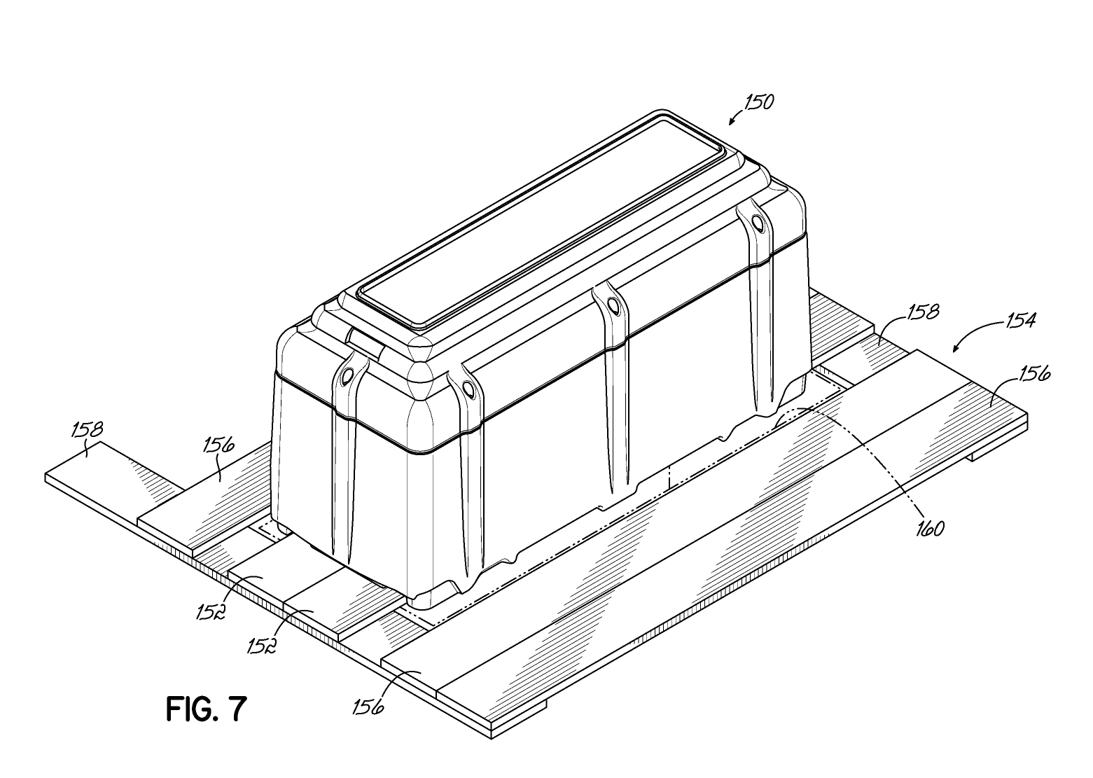

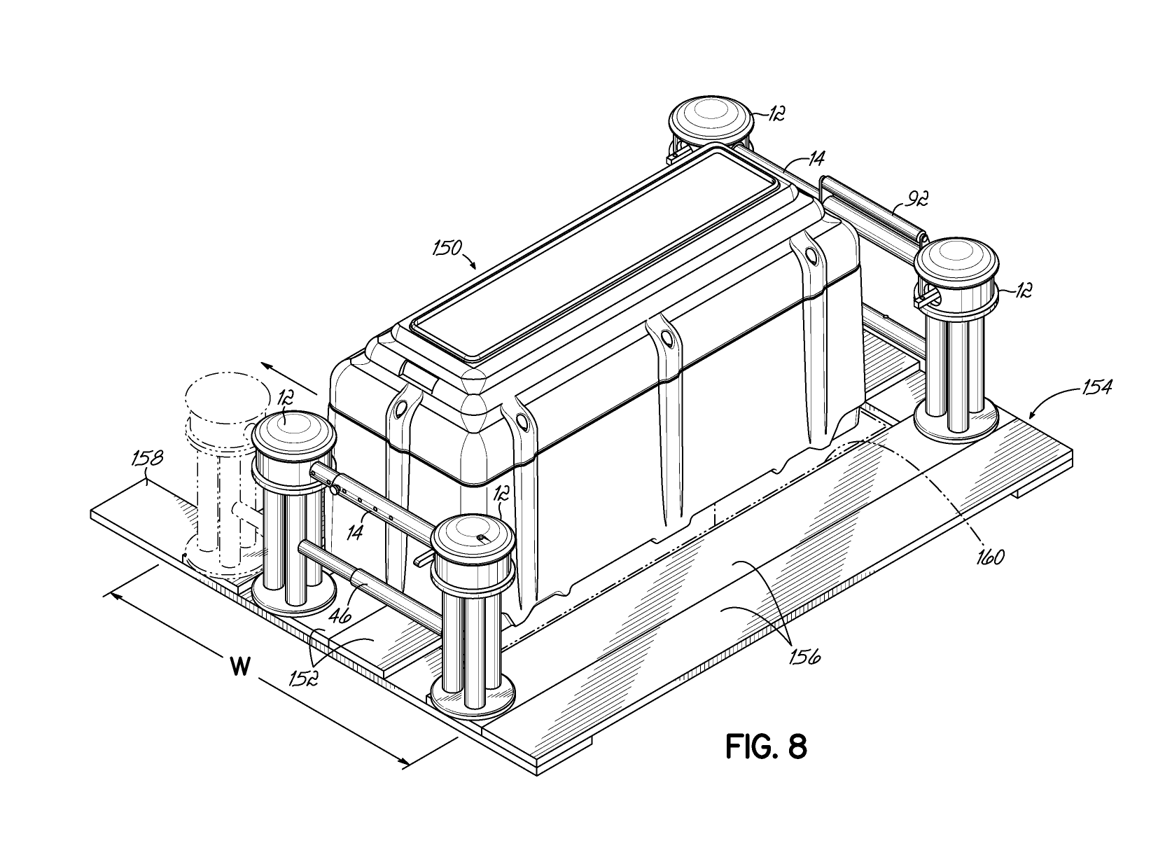

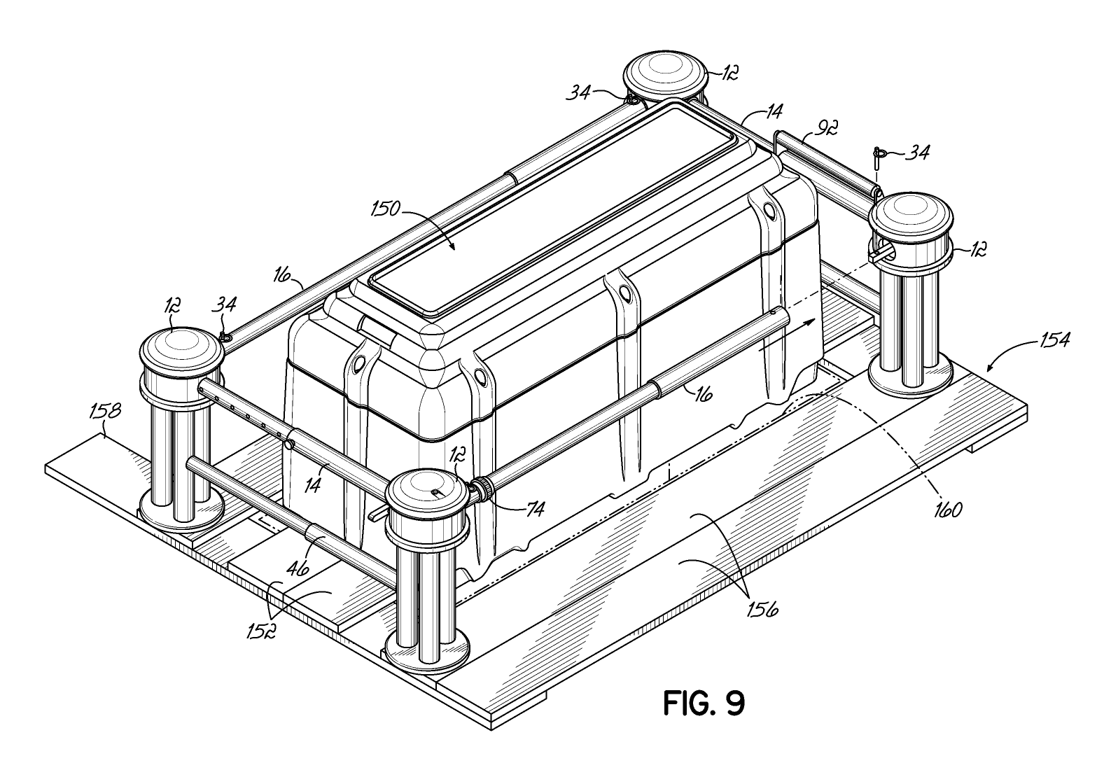

Referring now to FIGS. 7-16D, the use of the device 10 will be described. Referring to FIG. 7, a vault 150 is illustrated resting atop one or more center grave board 152. The vault 150 includes a vault base 151 and a vault lid 153. Center grave boards 152 are placed atop a rectangular grave frame 154 comprised of one or more side grave boards 156 and one or more end grave boards 158 which frame the grave 160. Referring to FIG. 8, the corner posts 12 and end tubes 14 are placed atop the grave frame 154 and are adjusted for width. Referring to FIG. 9, the side tubes 16 are adjusted for length and are connected to the corner posts 12 with pull pins 34.

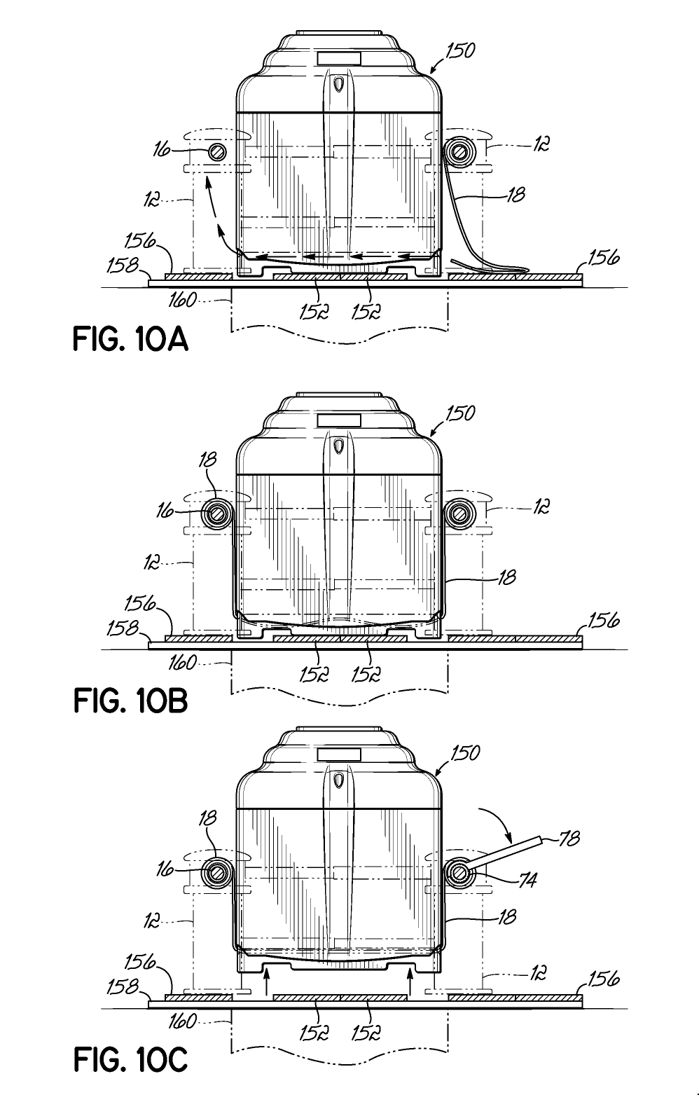

Referring to FIGS. 10A-10D, 17, 18A, and 18B, first ends of the first pair of straps 18 are rotatably fixedly secured to one of the side tubes 16, are threaded beneath the vault 150 and above center grave boards 152, and are rotatably fixedly secured to the other side tube 16. Note that transversely extending slots 157 formed in the bottom of the vault base 151 (FIG. 10D) facilitate the threading of the pair of straps 18 between the vault 150 and the grave boards 152. The vault 150 is lifted with the first pair of straps 18 by operating the power transmission assembly 22 by rotating gear 74 with spanner wrench 78. Center grave boards 152 can then be removed from beneath the vault 150 (FIG. 10D).

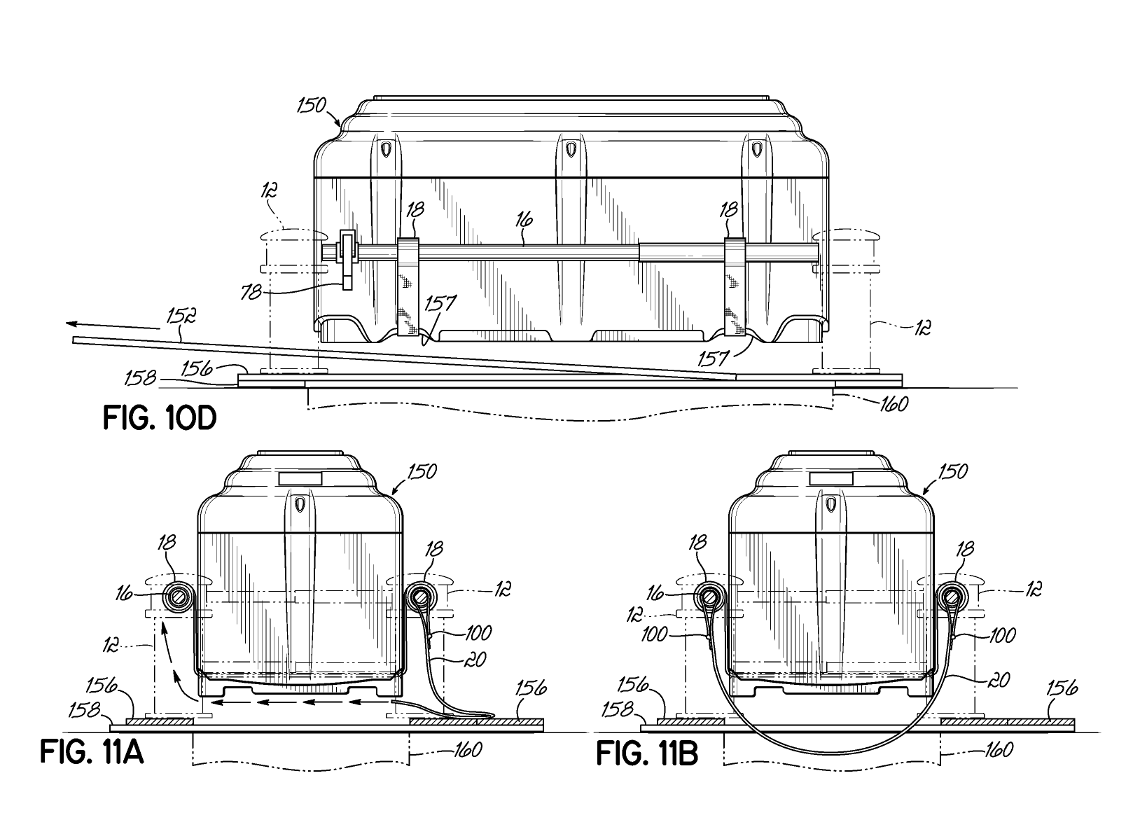

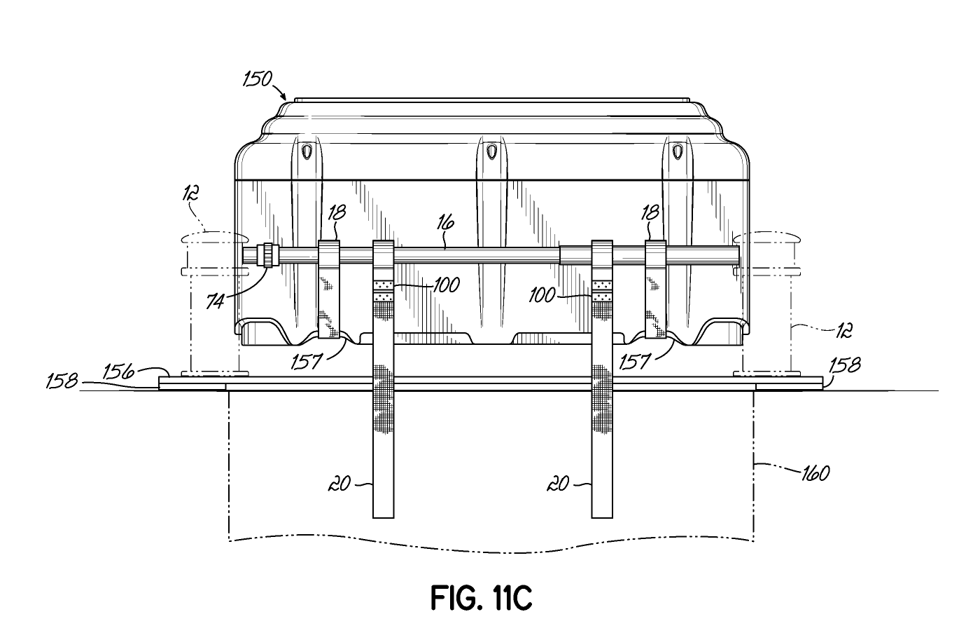

Referring to FIGS. 6, 6A, 6B, and 11A-11C, first ends of the second pair of straps 20 are removably connected loosely around one of the side tubes 16, are threaded beneath the vault 150, and are removably connected loosely around the other side tube 16 with the connectors 100. The second pair of straps 20 is draped downwardly into the grave 160.

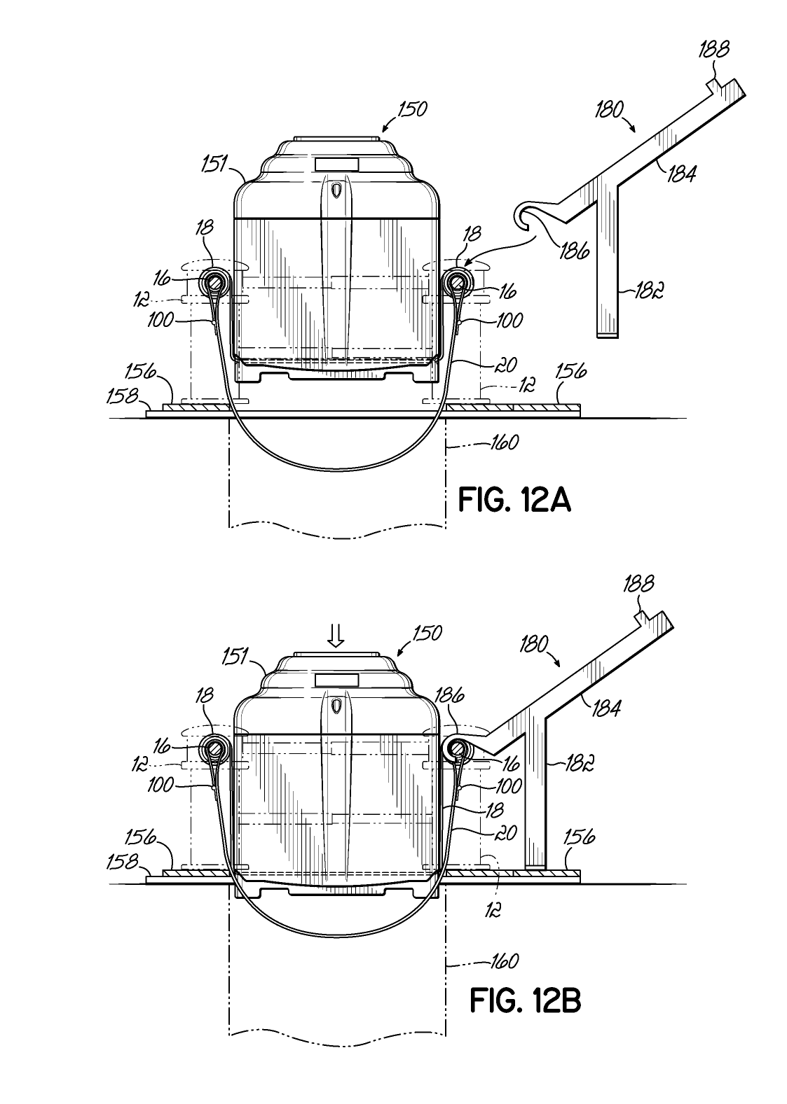

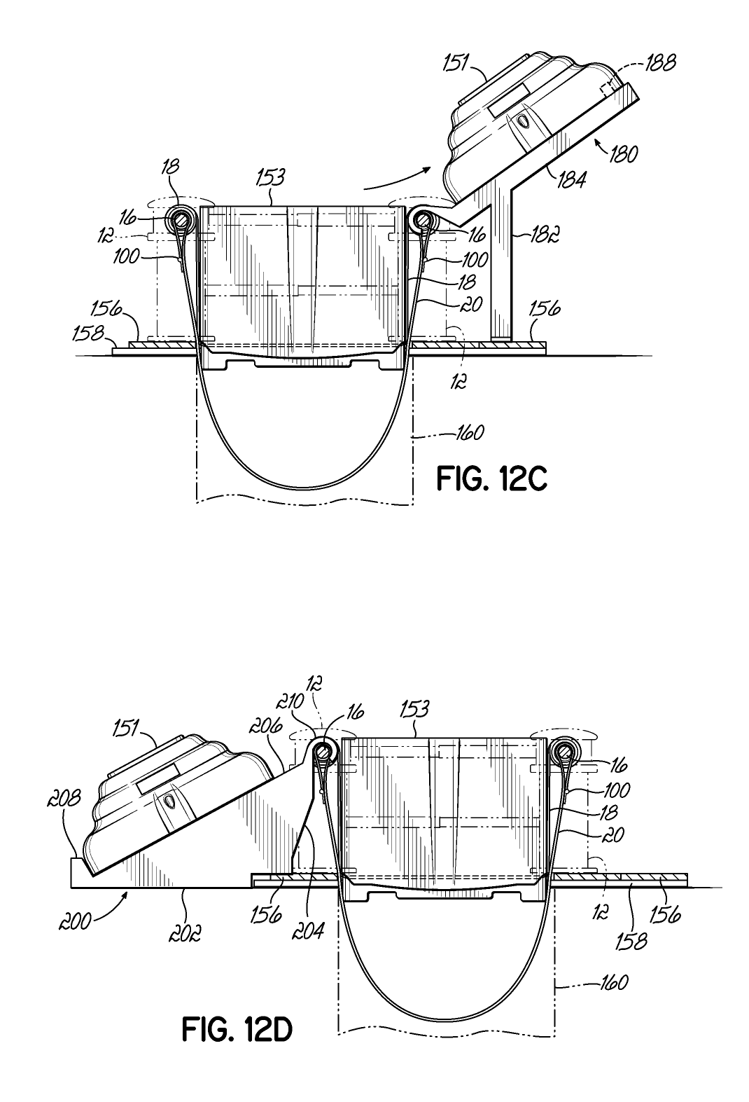

Referring to FIGS. 12A-12D, a vault lid display structure 180 is illustrated. The display structure 180 includes a generally vertical standard 182, at the upper end of which is an angled arm 184 having a connecting portion, for example a downwardly facing hook 186, on the lower end and an upwardly extending bar 188 on the opposite higher end. The hook 186 is placed over or otherwise connected to a side tube 16 and the foot of the standard 182 is rested atop one of the side grave boards 156. The vault 150 is lowered slightly by releasing the brake mechanism of the power transmission assembly 22 with lever 70 and then reapplying the brake with lever 70. The vault lid 151 can then be slid off of the vault body 153 and slid upwardly on arm 184 until an inner edge of the vault lid 151 is supported on an outer edge of the bar 188. Two such vault lid display structures can be used for stability. When viewed from the front of the grave, the vault lid 151 extends rearwardly and upwardly so as to be visible by mourners. Alternatively, as shown in FIG. 12D, the vault lid 151 can be supported on an alternative vault lid display structure 200. This vault lid display structure 200 has a base 202 which rests on the ground and/or the grave boards 156, an upwardly extending back 204, a downwardly and forwardly extending support surface 206, and a lip 208 on the lower end of the support surface 206. The upper end of the back 204 has a connecting portion, for example a downwardly facing hook 210, which is placed over or otherwise connected to a side tube 16. The vault lid 151 can then be slid off of the vault body 153 and slid downwardly on support surface 206 until an outer edge of the vault lid 151 is supported on an inner edge of the lip 208. Two such vault lid display structures can be used for stability. When viewed from the front of the grave, the vault lid 151 extends forwardly and downwardly so as to be visible by mourners.

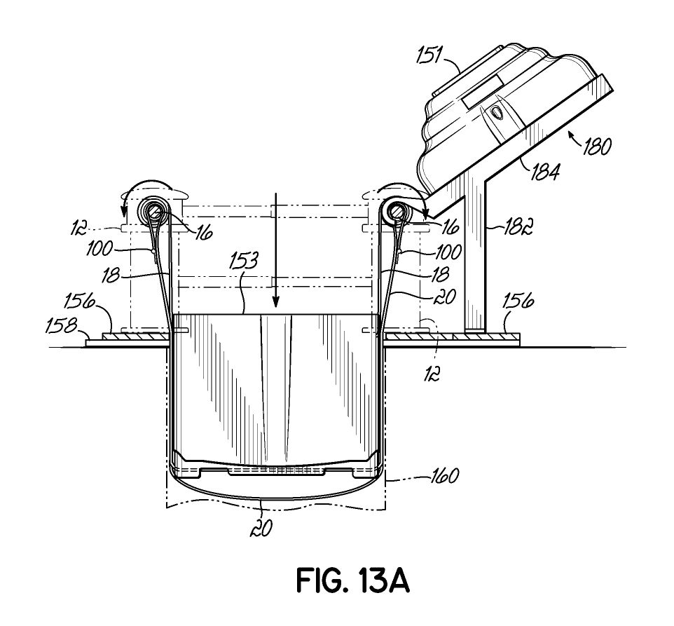

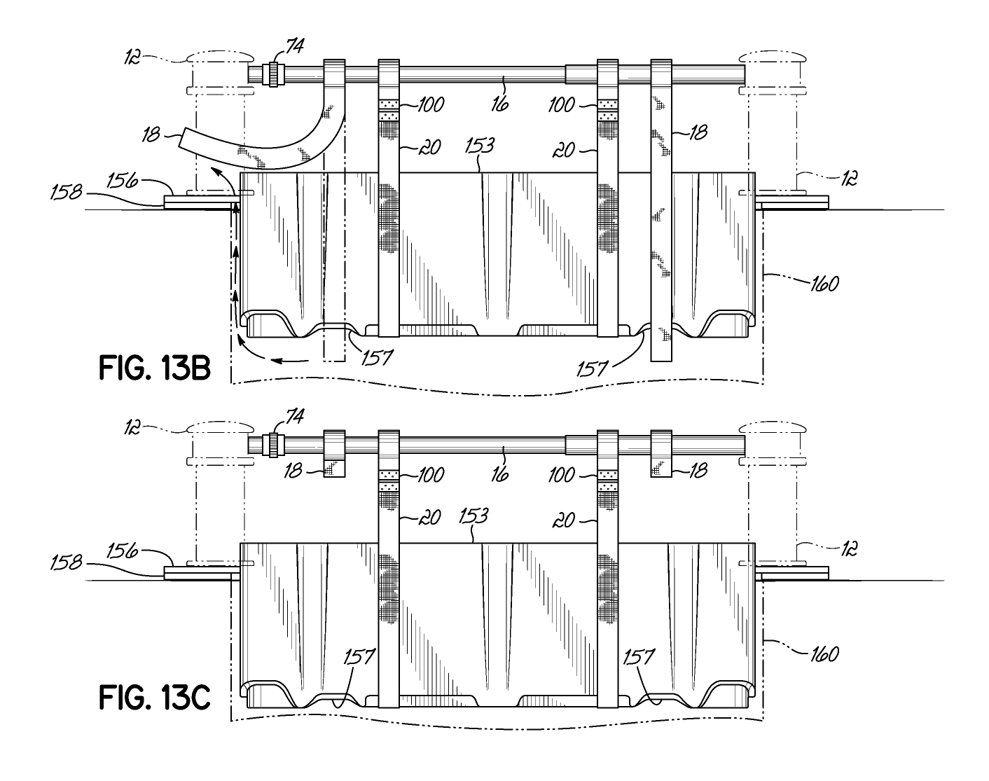

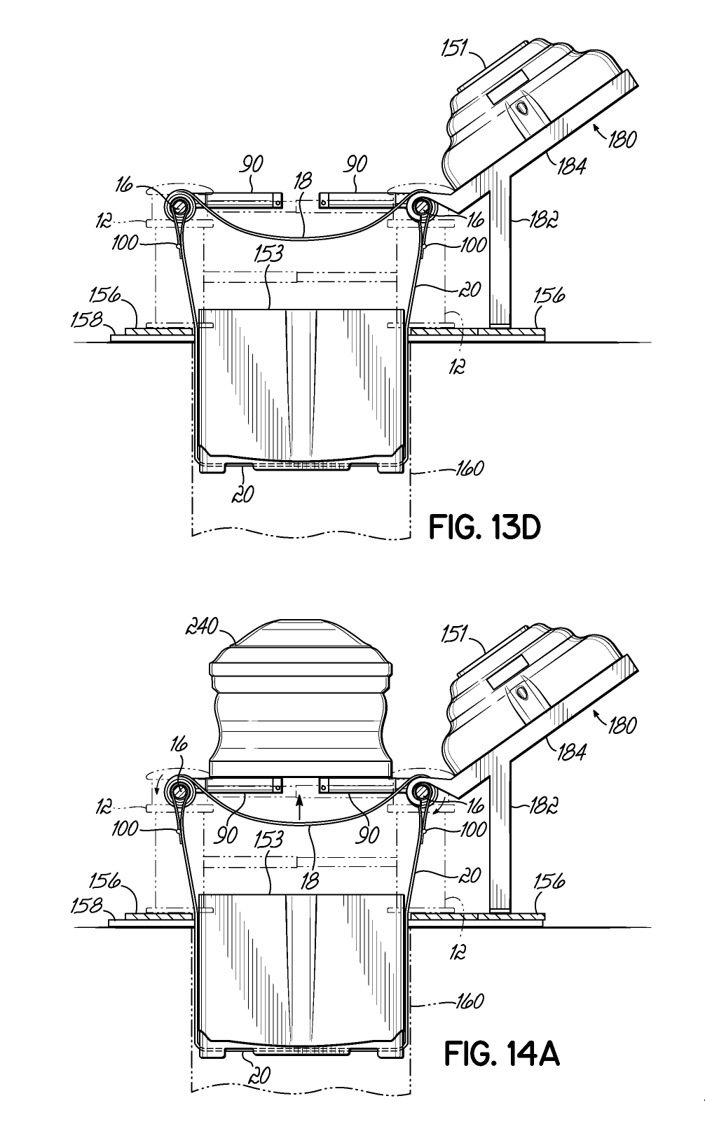

Referring to FIGS. 13A-13D, the brake can then be released again via lever 70 to operate the power transmission assembly 22 and the vault body 153 lowered until the vault body 153 is supported by the second pair of straps 20. The first pair of straps 18 is then removed from beneath the vault body 153, the vault body being supported by the second pair of straps 20.

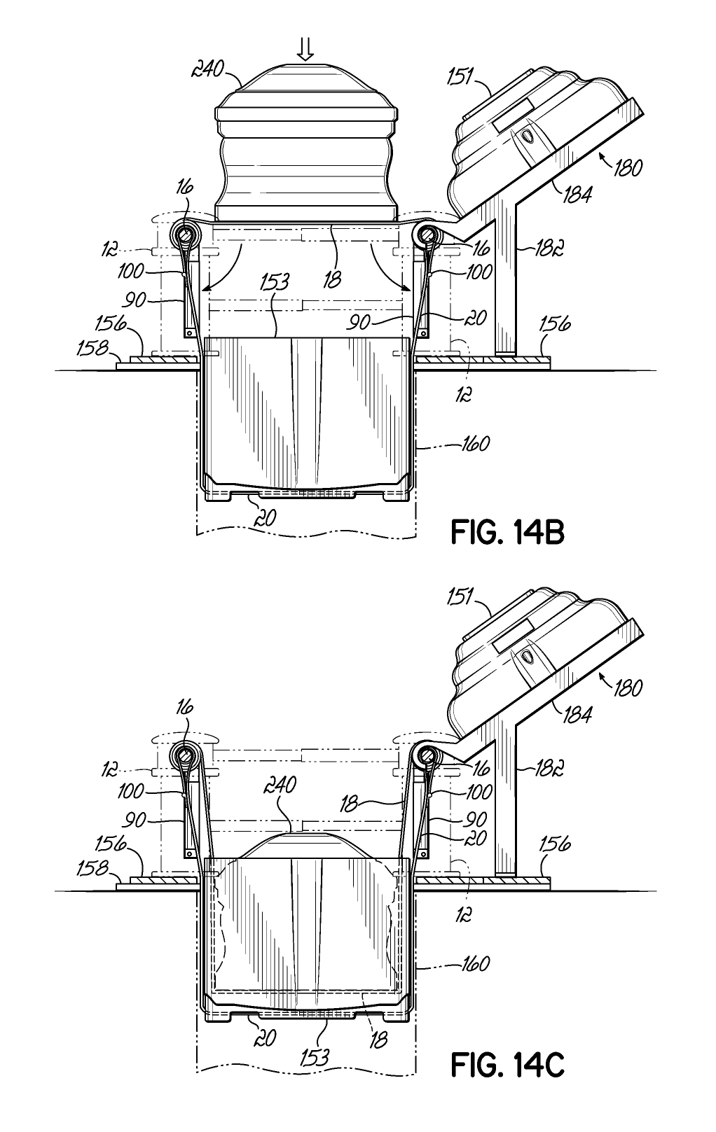

Referring to FIGS. 14A-14C, the slack is removed from the first pair of straps 18 via the power transmission assembly 22 and the casket placer rollers 90 are positioned in their horizontal casket supporting position. Casket 240 is then positioned atop the device 10. The casket placer rollers 90 are pivoted downwardly, and the brake is released with lever 70 to lower the casket 240 into the vault base 153. The first pair of straps is then removed from beneath the casket 240.

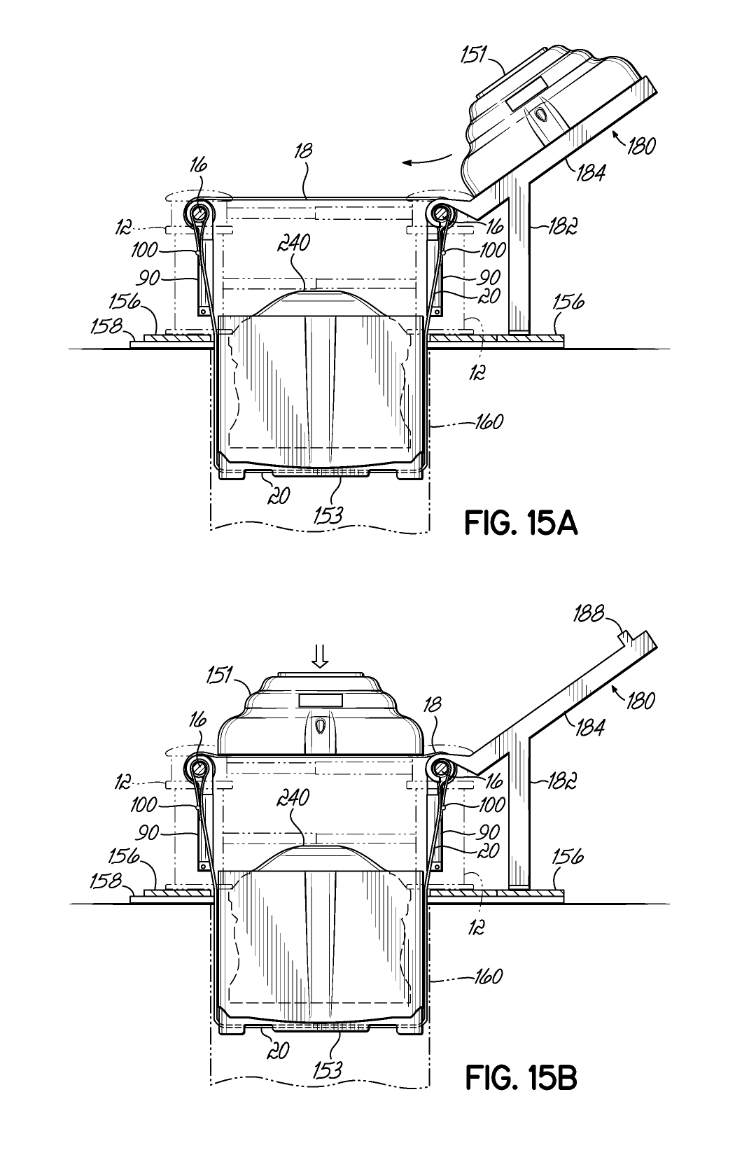

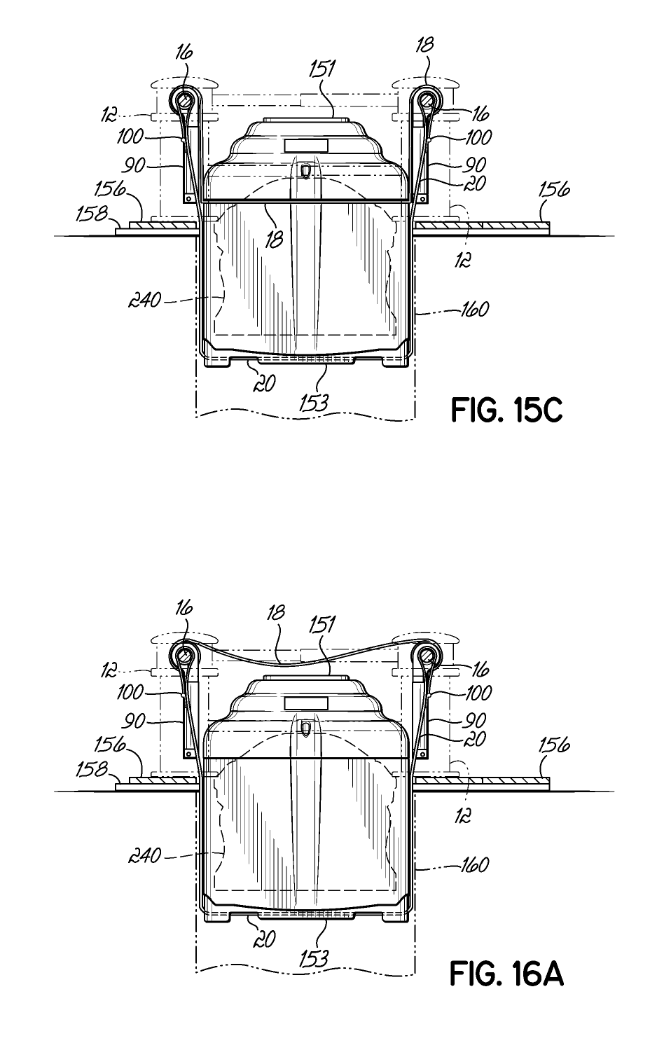

Referring to FIGS. 15A-15C, the slack is removed from the first pair of straps 18 via the power transmission assembly 22 and the vault lid 151 is positioned on the straps. The brake is released with lever 70 to operate the power transmission assembly 22 to lower the lid 151 onto the vault base 153. The lid 151 may then be secured to the vault base 153 with fasteners.

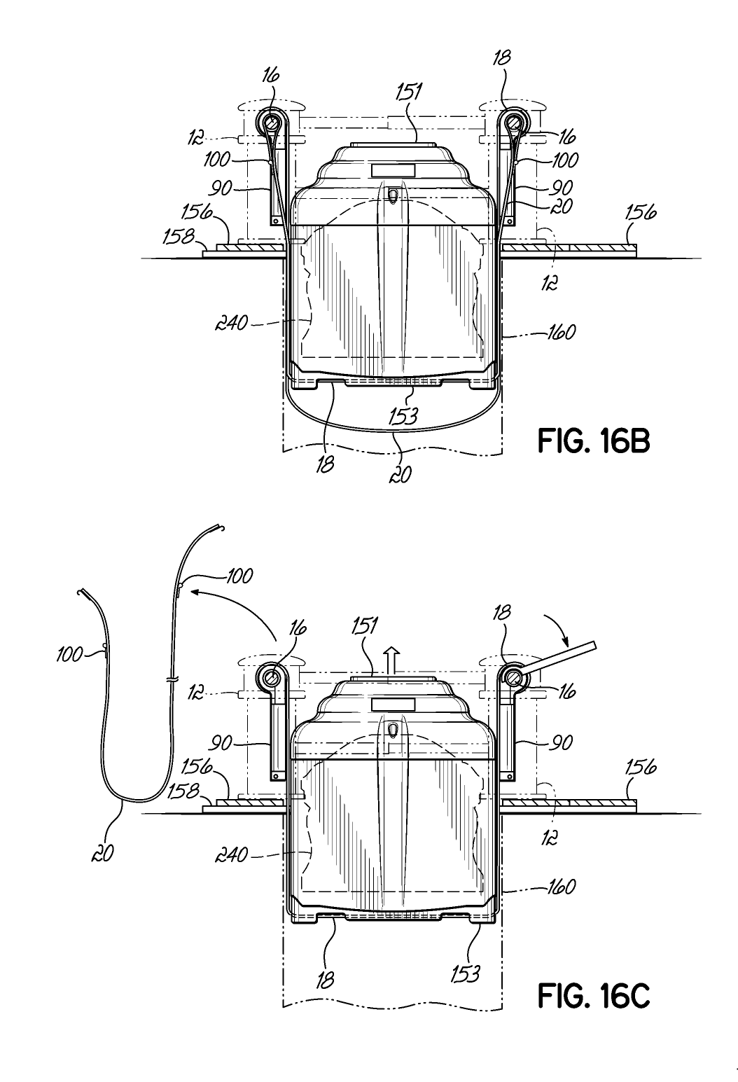

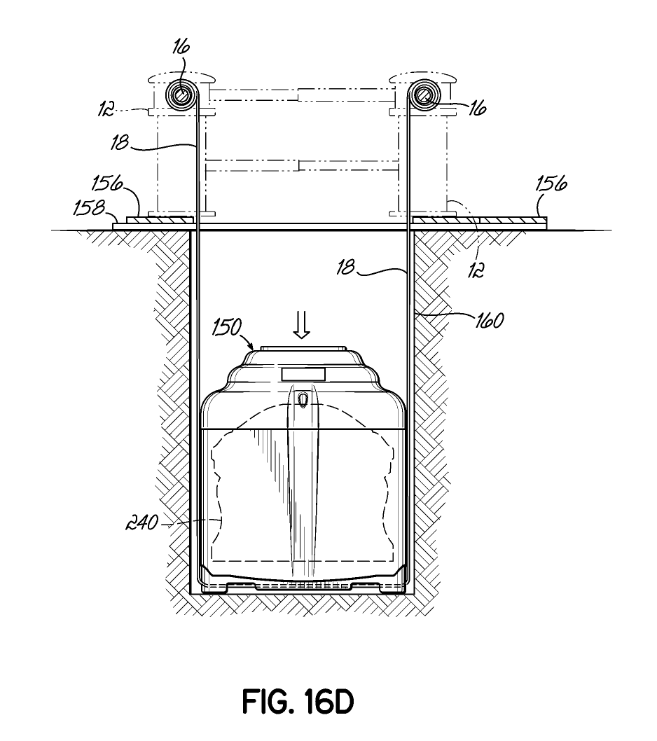

Referring to FIGS. 16A-16D, the first pair of straps 18 is then positioned under the vault 150. The vault 150 and casket 240 are then lifted by the first pair of straps 18 via the power transmission assembly 22 by rotating the gear 74 with the spanner wrench 78. The second pair of straps 20 is then removed from beneath the vault 150, and the brake is released with lever 70 to operate the power transmission assembly 22 to lower and the vault 150 and casket 240 into the grave with the first pair of straps 18. Finally, the first pair of straps 18 is then removed from beneath the vault 150 by detaching each center strap section 18a from one or both of its respective end strap sections 18b and withdrawing both center strap sections 18a of the pair from beneath the vault 150.

The embodiments shown and described are merely for illustrative purposes only. The drawings and the description are not intended to limit in any way the scope of the claims. Those skilled in the art will appreciate various changes, modifications, and other embodiments. All such changes, modifications and embodiments are deemed to be embraced by the claims. Accordingly, the scope of the right to exclude shall be limited only by the following claims and their equivalents.

What is claimed is:

1. A universal casket and vault lifting and lowering device comprising:
four corner posts,
a pair of end tubes, one of which is connected between two of said corner posts at each end of said device,
a pair of side tubes, one of which is connected between two of said corner posts at each side of said device,
a pair of straps, each having opposite ends rotatably fixed to a respective one of said side tubes,
a power transmission assembly for rotating said pair of side tubes in a first direction to wind said straps around said side tubes to take up slack in said straps and for rotating said pair of side tubes in a second direction to unwind said straps and create slack in said straps, and
a gear mounted to one of said side tubes which, when rotated, rotates both of said side tubes in the first direction and bypasses a portion of said power transmission assembly.

2. The device of claim 1 wherein said power transmission assembly comprises:
a worm, rotatable by a handle,
said worm engaging a worm gear mounted on a shaft to impart rotation to said shaft, said shaft carrying a bevel gear at each end, and
a bevel gear on an end of each said side tube, each said side tube bevel gear engaged by a respective one of said bevel gears on said shaft.

3. The device of claim 2 wherein when said gear mounted to said one side tube is rotated to rotate both of said side tubes in the first direction, the weight of a load lifted thereby is not transmitted through said worm and worm gear.

4. The device of claim 3 wherein said gear mounted to said one side tube is engageable with and rotatable by a spanner wrench.

5. A universal casket and vault lifting and lowering device comprising:
four corner posts,
a pair of end tubes, one of which is connected between two of said corner posts at each end of said device,
a pair of side tubes, one of which is connected between two of said corner posts at each side of said device,
a pair of straps, each having opposite ends rotatably fixed to a respective one of said side tubes, and
a power transmission assembly for rotating said pair of side tubes in a first direction to wind said straps around said side tubes to take up slack in said straps and for rotating said pair of side tubes in a second direction to unwind said straps and create slack in said straps,
each end of each of said pair of side tubes being removably connected to a respective shaft, extending from a respective corner post, by a removable pin.

6. A universal casket and vault lifting and lowering device comprising:
four corner posts,
a pair of end tubes, one of which is connected between two of said corner posts at each end of said device,
a pair of side tubes, one of which is connected between two of said corner posts at each side of said device,
a first pair of straps, each having opposite ends rotatably fixed to a respective one of said side tubes,
a second pair of straps, each having opposite ends looped around a respective one of said side tubes, and
a power transmission assembly for rotating said pair of side tubes in a first direction to wind said first pair of straps around said side tubes to take up slack in said first pair of straps and for rotating said pair of side tubes in a second direction to unwind said first pair of straps and create slack in said first pair of straps, rotation of said side tubes neither winding nor unwinding said second pair of straps.

7. A universal casket and vault lifting and lowering device comprising:
four corner posts,
a pair of end tubes, one of which is connected between two of said corner posts at each end of said device,
a pair of side tubes, one of which is connected between two of said corner posts at each side of said device,
a first pair of straps, each having opposite ends rotatably fixed to a respective one of said side tubes,
a second pair of straps, each having opposite ends looped around a respective one of said side tubes,
a power transmission assembly for rotating said pair of side tubes in a first direction to wind said first pair of straps around said side tubes to take up slack in said first pair of straps and for rotating said pair of side tubes in a second direction to unwind said first pair of straps and create slack in said first pair of straps, rotation of said side tubes neither winding nor unwinding said second pair of straps, and
a gear mounted to one of said side tubes which, when rotated, rotates both of said side tubes in the first direction and bypasses a portion of said power transmission assembly.

8. The device of claim 7 wherein said power transmission assembly comprises:
a worm, rotatable by a handle,
said worm engaging a worm gear mounted on a shaft to impart rotation to said shaft, said shaft carrying a bevel gear at each end, and
a bevel gear on an end of each said side tube, each said side tube bevel gear engaged by a respective one of said bevel gears on said shaft.

9. The device of claim 8 wherein when said gear mounted to said one side tube is rotated to rotate both of said side tubes in the first direction, the weight of a load lifted thereby is not transmitted through said worm and worm gear.

10. The device of claim 9 wherein said gear mounted to said one side tube is engageable with and rotatable by a spanner wrench.

11. The device of claim 7 wherein each end of each of said pair of side tubes are removably connected to a respective shaft, extending from a respective corner post, by a removable pin.

12. A method of lowering a vault and a casket into a grave, the vault having a vault base and a vault lid, the method comprising the steps of:
providing a universal casket and vault lifting and lowering device comprising:
four corner posts,
a pair of end tubes, one of which is connected between two of the corner posts at each end of the device,
a pair of side tubes, one of which is connected between two of the corner posts at each side of the device,
a first pair of straps, each strap having opposite ends rotatably fixed to a respective one of the side tubes,
a second pair of straps, each strap having opposite ends looped around a respective one of the side tubes, and
a power transmission assembly for rotating the pair of side tubes in a first direction to wind the first pair of straps around the side tubes to take up slack in the first pair of straps and for rotating the pair of side tubes in a second direction to unwind the first pair of straps and create slack in the first pair of straps, rotation of the side tubes neither winding nor unwinding the second pair of straps,
positioning the first pair of straps beneath the vault base,
operating the power transmission assembly to lower the vault base with the first pair of straps until the vault base is supported by the second pair of straps,
removing the first pair of straps from beneath the vault base,
positioning the first pair of straps beneath the casket,
operating the power transmission assembly to lower the casket with the first pair of straps until the casket is supported by the vault base,
removing the first pair of straps from beneath the casket,
positioning the first pair of straps beneath the vault base,
operating the power transmission assembly to lift the vault base and casket with the first pair of straps,
removing the second pair of straps from beneath the vault base, and
operating the power transmission assembly to lower the vault base and casket into the grave with the first pair of straps.

13. The method of claim 12 wherein the universal casket and vault lifting and lowering device further comprises a gear mounted to one of the side tubes which, when rotated, rotates both of the side tubes in the first direction and bypasses a portion of the power transmission assembly, and wherein the step of operating the power transmission assembly to lift the vault base and casket with the first pair of straps comprises rotating the gear mounted to the one side tube.

14. The method of claim 13 wherein the power transmission assembly comprises a worm, rotatable by a handle, the worm engaging a worm gear mounted on a shaft to impart rotation to the shaft, the shaft carrying a bevel gear at each end, and a bevel gear on an end of each side tube, each side tube bevel gear engaged by a respective one of the bevel gears on the shaft, wherein when the gear mounted to the one side tube is rotated to rotate both of the side tubes in the first direction, the weight of the vault and casket lifted thereby is not transmitted through the worm and worm gear.

15. The method of claim 14 wherein the step of rotating the gear mounted to the one side tube comprises rotating the gear with a spanner wrench.

16. The method of claim 15 further comprising the step of disengaging a brake mechanism of the power transmission assembly prior to rotating the gear mounted to the one side tube with a spanner wrench.

17. The method of claim 12 wherein the step of removing the second pair of straps from beneath the vault base comprises detaching at least one end of each strap from its respective side tube.

18. The method of claim 12 wherein the second pair of straps are positioned between the first pair of straps.

19. The method of claim 12 further comprising the step of:
subsequent to the step of removing the first pair of straps from beneath the casket and prior to the step of positioning the first pair of straps beneath the vault base, positioning the first pair of straps beneath the vault lid, and operating the power transmission assembly to lower the vault lid onto the vault base with the first pair of straps.

20. The method of claim 12 further comprising the step of:
supporting the vault on a grave board,
positioning the first pair of straps beneath the vault,
operating the power transmission assembly to lift the vault with the first pair of straps,
removing the grave board from beneath the vault.

21. The device of claim 6 further comprising:
a vault lid display structure comprising a generally vertical standard, an upwardly and rearwardly extending vault lid support arm mounted at an upper end of said standard, said support arm having a connecting portion on a forward end thereof and an upwardly extending bar on a rearward end thereof, said connecting portion connected to one of said side tubes of said device, a foot of said standard adapted to rest atop a generally horizontal supporting surface, an outer edge of said bar adapted to support an inner edge of a vault lid.

22. The device of claim 21 wherein said connecting portion is a downwardly facing hook.

23. The device of claim 6 further comprising:
a vault lid display structure comprising a base adapted to rest atop a generally horizontal supporting surface, an upwardly extending back, a downwardly and forwardly extending vault lid support surface, a lip on a lower end of said support surface, and a connecting portion on an upper end of said back, said connecting portion connected to one of said side tubes of said device, an inner edge of said lip adapted to support an outer edge of a vault lid.

24. The device of claim 23 wherein said connecting portion is a downwardly facing hook.

25. The method of claim 12 wherein the step of removing the first pair of straps from beneath the vault base comprises detaching at least one end of each strap from its respective side tube.
